(19) United States
(12) Patent Application Publication
(10) Pub. No.: US 2026/0234005 A1
(43) Pub. Date: Aug. 13, 2026

(54) METHOD FOR DRY RECYCLING AND STRUCTURE REGENERATION OF LAYERED CARBON MATERIALS

(71) Applicant: RIKOMAY RECYCLING SINGAPORE PTE. LTD., Singapore (SG)

(72) Inventors: Yu ZHANG, Wuhan (CN); Yuancheng CAO, Wuhan (CN); Jianfeng ZHANG, Wuhan (CN); Sheng QIAN, Wuhan (CN); Huxun LUO, Wuhan (CN); Xiaoxi PENG, Wuhan (CN); Tian ZHENG, Wuhan (CN); Hang LIAO, Wuhan (CN); Fan HU, Wuhan (CN); Bin ZHOU, Wuhan (CN)

(21) Appl. No.: 19/640,429

(22) Filed: Apr. 7, 2026

(30) Foreign Application Priority Data
Sep. 29, 2025 (CN) 202511411618.1

(51) Int. Cl. C01B 32/205

(52) U.S. Cl. CPC C01B 32/205

(57) ABSTRACT

A method for dry recycling and structure regeneration of a layered carbon material, in which a waste layered carbon material is pretreated, mixed with asphalt, and subjected to gas-phase infiltration in a nitrogen atmosphere at 300-500° C., pyrolytic deposition at 800° C. under vacuum, and isostatic-pressing densification at 5 MPa in an inert gas atmosphere to obtain an intermediate product; the intermediate product is heated from 800° C. to 1500° C., from 1500° C. to 2500° C., from 2500° C. to 2850° C., kept at 2850° C. under an axial pulse pressure for 1-6 h; and the resultant product is cooled and post-treated.

### CROSS-REFERENCE TO RELATED APPLICATIONS

This application claims the benefit of priority from Chinese Patent Application No. 202511411618.1, filed on Sep. 29, 2025. The content of the aforementioned application, including any intervening amendments thereto, is incorporated herein by reference in its entirety.

### TECHNICAL FIELD

This application relates to restoration of layered carbon materials, and more particularly to a method for dry recycling and structure regeneration of layered carbon materials.

### BACKGROUND

The existing recovery technologies for waste layered carbon materials, such as waste graphite from batteries, primarily rely on wet processes, such as an acid treatment, which struggles with the following defects.

### (1) Acid Etching Causes Damage to the Crystal Structure.

A reaction mechanism is as follows: hydrogen ions are intercalated into the crystal lattice: C+2H⁺→CH₂, causing the conversion of sp²-hybridized carbon to sp³-hybridized carbon.

This conversion phenomenon is evidenced by Raman spectroscopy and X-ray diffraction (XRD) results, in which an increase is observed in an intensity ratio of D-band to G-band (ID/IG ratio) from 0.23 to 0.68, and an interlayer spacing is expanded from 0.336 nm to 0.355 nm.

### (2) Strong Acid-Induced Oxidation is Uncontrollable.

A reaction mechanism of nitric acid oxidation is as follows: C+4HNO₃→CO₂+4NO₂+2H₂O, causing breakage of a carbon layer conjugated system.

Evidence is as follows: an X-ray photoelectron spectroscopy shows that a proportion of C—O bonds exceeds 15%.

### (3) High-Temperature Restoration Becomes Ineffective.

A mechanism is as follows: structural defects generated by the acid etching significantly increase an activation energy for carbon atom migration.

Evidence is as follows: the activation energy increases from 120 kJ/mol to 180 kJ/mol, making it difficult to effectively restore a crystal structure through high-temperature restoration.

### SUMMARY

The present disclosure provides a method for dry recycling and structure regeneration of layered carbon materials, so as to solve problems in the prior art that acid etching will cause damage to the sp²-hybridized carbon network; there are excessively high energy barriers required for high-temperature restoration; and the wet processes will bring environmental pollution.

Technical solutions of the present disclosure are described as follows.

A method for dry recycling and structure regeneration of layered carbon materials is provided, comprising:
(S10) pretreating a waste layered carbon material;
(S20) mixing a pretreated waste layered carbon material with asphalt, followed by gas-phase infiltration in a nitrogen atmosphere at 300-500° C. to allow small-molecule aromatic hydrocarbons to diffuse into defect sites of the pretreated waste layered carbon material, so as to obtain a mixture;
performing pyrolytic deposition on the mixture at 800° C. under vacuum to obtain a first intermediate product, wherein the small-molecule aromatic hydrocarbons undergo dehydrogenation condensation to release hydrogen gas and form polycyclic aromatic hydrocarbon radicals, and the polycyclic aromatic hydrocarbon radicals undergo in-situ condensation through polymerization at the defect sites of the pretreated waste layered carbon material to form a continuous carbon film; performing isostatic-pressing densification on the first intermediate product at a pressure of 5-7 MPa in an inert gas atmosphere to force the continuous carbon film to experience plastic flow and fill micropores with a size smaller than 50 nm to obtain a second intermediate product;
(S30) heating the second intermediate product from 800° C. to 1500° C. at a rate of 5-10° C./min to realize defect identification and transformation to obtain a third intermediate product; heating the third intermediate product from 1500° C. to 2500° C. at a rate of 10-12° C./min to realize atomic directional migration to obtain a fourth intermediate product; and heating the fourth intermediate product from 2500° C. to 2850° C., and keeping the fourth intermediate product at 2850° C. under an axial pulse pressure for 1-6 h to induce Bernal stacking to realize ordered lattice reconstruction, so as to obtain a fifth intermediate product; and
(S40) subjecting the fifth intermediate product to deagglomeration and magnetic separation to obtain a regenerated material.

In an embodiment, the waste layered carbon material is waste graphite; and step (S10) comprises:
crushing the waste layered carbon material, followed by impurity removal.

In an embodiment, in step (S20), the asphalt accounts for 5-10 wt. % of the pretreated waste layered carbon material.

In an embodiment, the small-molecule aromatic hydrocarbons are anthracene and phenanthrene.

In an embodiment, the defect sites are lattice vacancies and interlayer cracks.

In an embodiment, in step (S20), the pyrolytic deposition is performed at a vacuum degree of 10⁻² Pa.

In an embodiment, the continuous carbon film has an amorphous-graphene hybrid structure with an intensity ratio of D-band to G-band (ID/IG ratio) of 0.45-0.55.

In an embodiment, an inert gas in the inert gas atmosphere is argon gas or nitrogen gas.

In an embodiment, in step (S20), the isostatic-pressing densification is performed to increase a density of the continuous carbon film to 1.6-1.9 g/cm³.

In an embodiment, during the defect identification and transformation, an oxygen-containing defect reaction is triggered as follows: C+O→CO₂, and Stone Wales defect rotation is activated to realize transformation of five-membered carbon rings and seven-membered carbon rings into six-membered carbon rings, with a transformation rate of 95% as verified by molecular simulation.

In an embodiment, during the atomic directional migration, under the guidance of the continuous carbon film, an atomic migration energy barrier is reduced, a vacancy filling energy barrier decreases by 1.3 eV, and an interlayer transition energy barrier decreases by 1.4 eV.

In an embodiment, in step (S30), the axial pulse pressure is 0.4-0.55 MPa, and is applied in a 5-second on/5-second off mode.

The present disclosure has the following beneficial effects.

(1) The gas-phase infiltration is performed to allow the small-molecule aromatic hydrocarbons to diffuse to the defect sites of the layered carbon material. Then, the pyrolytic deposition is performed, where the small-molecule aromatic hydrocarbons undergo dehydrogenation condensation to release hydrogen gas and form the polycyclic aromatic hydrocarbon radicals, and the polycyclic aromatic hydrocarbon radicals undergo in-situ condensation through polymerization at defect sites of the waste layered carbon material to form the continuous carbon film. The continuous carbon film has the amorphous-graphene hybrid structure with the ID/IG ratio of about 0.5 as detected by Raman spectroscopy, indicating a composite characteristic of ordered graphitic domains and flexible amorphous regions. As verified by scanning electron microscopy (SEM), the continuous carbon film completely covers surface defects, such as scratches and pores, without cracks or peeling. Then, the high-pressure densification is performed to force the continuous carbon film to plastic flow and fill micropores smaller than 50 nm, so as to improve the density of the continuous carbon film. The density of the continuous carbon film is increased from about 1.2 g/cm³ to 1.6-1.9 g/cm³, which approaches a theoretical density of graphite of 2.26 g/cm³. In the high-pressure densification, pressure induces a dual interface strengthening mechanism of mechanical interlocking and chemical bonding between the continuous carbon film and a substrate, forming a dual structure of mechanical interlocking and chemical bonding. Finally, a gradient high-temperature restoration is performed to promote the oxygen-containing defect reaction of C+O→CO₂, and Stone Wales defect rotation is activated, where a rotation angle θ of a carbon ring is decreased from 150 to an energy minimum of 0°, so as to realize transformation of five-membered carbon rings and seven-membered carbon rings into six-membered carbon rings. Concurrently, under the guidance of the continuous carbon film, the atomic migration energy barrier is significantly reduced. As measured by in-situ transmission electron microscopy, the vacancy filling energy barrier decreases from 2.8 eV to 1.5 eV, and the interlayer transition energy barrier decreases from 3.2 eV to 1.8 eV The Bernal stacking is induced to realize ordered lattice reconstruction. Ion diffusion efficiency is improved, specifically, the high-pressure densification reduces electrolyte side reactions, increases and initial coulombic efficiency to 93.1% and enhances cycle stability. Cycle life is prolonged, specifically, a high-density film buffers volume changes, resulting in a capacity retention rate of >95% after 100 cycles; an interlayer spacing of the regeneration material is restored to a level of 0.336 nm, and the regeneration material has a specific capacity of 361.96 mAh/g and a 6 C rate capability retention of >84.5%. These improvements are attributed to reduced energy barriers and densification effects. Simultaneously, all-dry process achieves zero-pollution emission, no waste water or gas, and reduces energy consumption by 40%.

(2) The ultra-high vacuum environment of the pyrolytic deposition has dual roles as follows. First, the ultra-high vacuum environment isolates oxygen gas, preventing oxidation of the continuous carbon film, and ensuring pure chemical bonding. Second, by-product dissipation is promoted. The by-product H₂ is rapidly removed by a vacuum system, preventing porosity of the continuous carbon film caused by microbubbles.

(3) The polycyclic aromatic hydrocarbon radicals undergo in-situ condensation to realize atomic-level bonding restoration. At a low pressure of 5 MPa, plastic flow is activated, enabling cross-scale optimization of an atomic-micron structure. Such pressure is an optimized pressure to completely eliminate pores, with XRD showing that the continuous carbon film is dense and defect-free.

### BRIEF DESCRIPTION OF THE DRAWINGS

FIG. 1 is a morphology diagram of a pretreated waste layered carbon material according to an embodiment of the present disclosure.

FIG. 2 is a morphology diagram of a coated waste layered carbon material according to an embodiment of the present disclosure.

FIG. 3 is a morphology diagram of a material after gradient high-temperature restoration according to an embodiment of the present disclosure.

### DETAILED DESCRIPTION OF EMBODIMENTS

The principle and characteristics of the present disclosure will be described with reference to the accompanying drawings. The embodiments herein are only illustrative rather than limiting the disclosure.

A method for dry recycling and structure regeneration of layered carbon materials includes the following steps.

(S10) A waste layered carbon material is pretreated, where the waste layered carbon material is waste graphite. The pretreatment includes crushing and impurity removal.

(S20) A pretreated waste layered carbon material is mixed with asphalt, followed by gas-phase infiltration in a nitrogen atmosphere at 300-500° C. to allow small-molecule aromatic hydrocarbons to diffuse into defect sites of the pretreated waste layered carbon material, where the asphalt accounts for 5-10 wt. % of the pretreated waste layered carbon material, so as to obtain a mixture.

Pyrolytic deposition is performed on the mixture at 800° C. under a vacuum degree of 10⁻² Pa to obtain a first intermediate product, where the small-molecule aromatic hydrocarbons undergo dehydrogenation condensation to release hydrogen gas and form polycyclic aromatic hydrocarbon radicals, and the polycyclic aromatic hydrocarbon radicals undergo in-situ condensation through polymerization at the defect sites of the pretreated waste layered carbon material to form a continuous carbon film, where the continuous carbon film has an amorphous-graphene hybrid structure with an intensity ratio of D-band to G-band (ID/IG ratio) of 0.45-0.55 as detected by Raman spectroscopy, indicating a composite characteristic of ordered graphitic domains and flexible amorphous regions. As verified by scanning electron microscopy (SEM), the continuous carbon film completely covers surface defects, such as scratches and pores, without cracks or peeling. The vacuum degree of 10⁻² Pa ensures pure reactions, and has the following dual functions. First, the ultra-high vacuum environment isolates oxygen gas, preventing oxidation of the continuous carbon film, and ensuring pure chemical bonding. Second, by-product dissipation is promoted. The by-product H₂ is rapidly removed by a vacuum system, preventing porosity of the continuous carbon film caused by microbubbles.

Isostatic-pressing densification is performed on the first intermediate product at a pressure of 5-7 MPa in an inert gas atmosphere to force the continuous carbon film to experience plastic flow and fill micropores with a size smaller than 50 nm to obtain a second intermediate product, achieving cross-scale densification through physical compaction. In this way, the continuous carbon film is forced to experience plastic flow, filling micropores smaller than 50 nm, that is, nanopore filling, thereby increasing a density of the continuous carbon film, and achieving uniform and dense coating. The density of the continuous carbon film is increased from about 1.2 g/cm³ to 1.6-1.9 g/cm³, which approaches a theoretical density of graphite of 2.26 g/cm³. In the isostatic-pressing densification, pressure induces a dual interface strengthening mechanism of mechanical interlocking and chemical bonding between the continuous carbon film and a substrate, forming a dual structure of mechanical interlocking and chemical bonding.

In this step, the pressure of 5 MPa is selected for the following reasons. If the isostatic pressure of 3 MPa (relatively low pressure) is selected, micropore residues are still visible by SEM. If the isostatic pressure of 5 MPa (optimized pressure) is selected, pores are completely eliminated, with XRD showing that the continuous carbon film is dense and defect-free. If the isostatic pressure of 10 MPa (excessively high pressure) is selected, microcracks may be induced in the substrate. That is, the isostatic pressure below 3 MPa results in incomplete densification, while the isostatic pressure above 10 MPa damages the substrate.

(S30) The second intermediate product is heated from 800° C. to 1500° C. at a rate of 5-10° C./min to realize defect identification and transformation to obtain a third intermediate product. In this process, an oxygen-containing defect reaction of C+O→CO₂ is promoted, and Stone Wales defect rotation is activated, where a rotation angle θ of a carbon ring is decreased from 150 to an energy minimum of 0°, so as to control a CO concentration at 300 ppm (catalysis) and realize transformation of five-membered carbon rings and seven-membered carbon rings into six-membered carbon rings with a transformation rate of 95% verified by molecular simulation.

The third intermediate product is heated from 1500° C. to 2500° C. at a rate of 10-12° C./min to realize atomic directional migration to obtain a fourth intermediate product. In this process, an atomic migration energy barrier is significantly reduced. As measured by in-situ transmission electron microscopy, a vacancy filling energy barrier decreases from 2.8 eV to 1.5 eV, and the interlayer transition energy barrier decreases from 3.2 eV to 1.8 eV.

The fourth intermediate product is heated from 2500° C. to 2850° C., and is kept at 2850° C. under an axial pulse pressure of 0.4-0.55 MPa in a 5-second on/5-second off mode for 1-6 h to induce Bernal stacking to realize ordered lattice reconstruction so as to obtain a fifth intermediate product, that is, high lattice ordering is realized.

(S40) The fifth intermediate product is subjected to deagglomeration and magnetic separation to obtain a regenerated material.

Examples 1-3 are carried out based on the above solution, with difference lying in temperature keeping time at 2850° C., thereby achieving optimized verification of temperatures of gradient high-temperature restoration.

TABLE 1

| Maximum | | | Specific | |
|---|---|---|---|---|
| temperature | Keeping | Initial coulombic | capacity | Cu impurity |
| (° C.) | time (h) | efficiency (%) | (mAh/g) | content (ppm) |
| 2850° C. | 1 | 92.1 | 354.12 | 1.24 |
| 2850° C. | 2 | 92.7 | 355.74 | 0.74 |
| 2850° C. | 4 | 93.1 | 361.96 | 0.72 |

Referring Examples 1-3, optimal specific capacity and the initial coulombic efficiency are achieved at 2850° C. for 4 hours.

Examples 4-8 are carried out based on the above solution, with difference lying in different temperature keeping time at 2850° C., while a coating amount of asphalt is also different, thereby achieving verification of the coating amount of asphalt.

TABLE 2

| Maximum | | | Specific | |
|---|---|---|---|---|
| temperature | Keeping | Coating amount | capacity | Cu impurity |
| (° C.) | time (h) | of asphalt (%) | (mAh/g) | content (ppm) |
| 2850 | 2 | 5 | 354.4 | 1.54 |
| 2850 | 4 | 4 | 361 | 0.74 |
| 2850 | 4 | 6 | 362 | 0.68 |
| 2850 | 4 | 8 | 359 | 0.79 |
| 2850 | 4 | 10 | 358 | 0.80 |

Referring Examples 4-8, compared to the wet processes in the prior art, the present disclosure achieves breakthrough improvements in material performance, environmental friendliness, and economic efficiency.

TABLE 3
Revolutionary improvement of material performances

| Performance | | | Present | | Improvement |
|---|---|---|---|---|---|
| indicator | Prior art | | disclosure | | mechanism |
| Lattice | Interlayer | | Interlayer | | Asphalt-derived carbon |
| integrity | spacing | | spacing | | film effectively fills |
| | 0.355 nm | | 0.336 nm | | interlayer defects |
| Ion diffusion | 2.1 × | | 8.7 × | | Unblocked two- |
| coefficient | 10⁻⁹ cm²/s | | 10⁻⁹ cm²/s | | dimensional ion |
| | | | | | channels |
| Cu impurity | <50 | ppm | <5 | ppm | High-temperature |
| content | | | | | volatilization of |
| | | | | | impurities |
| Specific | 351 | mAh/g | 361 | mAh/g | High-temperature |

| | |
|---|---|
| capacity | restoration of layered |
| | structure |

TABLE 4
Benefit of environmental protection with
zero emissions throughout entire process

| | | Present | |
|---|---|---|---|
| Pollution source | Prior art | disclosure | Emission reduction effect |
| Fluorine- | 15 tons/ton | 0 | Complete elimination of |
| containing | material | | fluoride contamination risk |
| wastewater | | | to groundwater |
| NOₓ emissions | Generated | 0 | Reduction of PM2.5 |
| | during acid | | precursor formation |
| | pickling | | |
| Hazardous | >200 kg/ton | 0 | Complete elimination of |
| solid waste | material | | hazardous waste disposal |
| (acid sludge) | | | process and costs |

TABLE 5
Economic value advantage

| | | Present | Saving/ |
|---|---|---|---|
| | Prior art | disclosure | value-added |
| Cost item | (CNY/ton) | (CNY/ton) | amplitude |
| Energy | 10200 | 6800 | 33% (saving |
| consumption cost | | | 3400) |
| Wastewater | 5000 | 0 | 100% (saving |
| treatment cost | | | 5000) |
| Material lifetime | ~0.8 CNY/ | ~0.4 CNY/ | 50% decrease |
| value cost | (cycle Ah) | (cycle Ah) | |

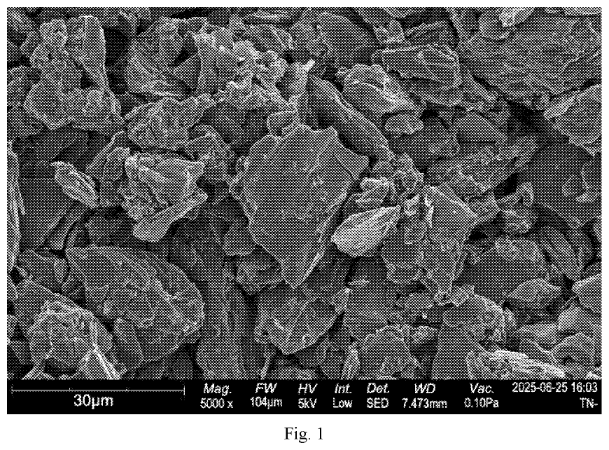

FIG. 1 is a morphology diagram of the pretreated waste layered carbon material, such as the graphite after pretreatment, indicating that a significant number of scratches, pores, and edge peeling occurs on a surface of the waste layered carbon material, which confirms that wet process causes severe damage to a crystal structure. Although a particle size becomes uniform, specifically, a median particle size (D50) is about 15 μm after the pretreatment of crushing and impurity removal, defects such as microcracks on the surface remain without restoration and must rely on subsequent coating processes for restoration. The result herein validates theory mentioned in the background that acid etching leads to destruction of sp²-hybridized carbon and expansion of the interlayer spacing to 0.355 nm.

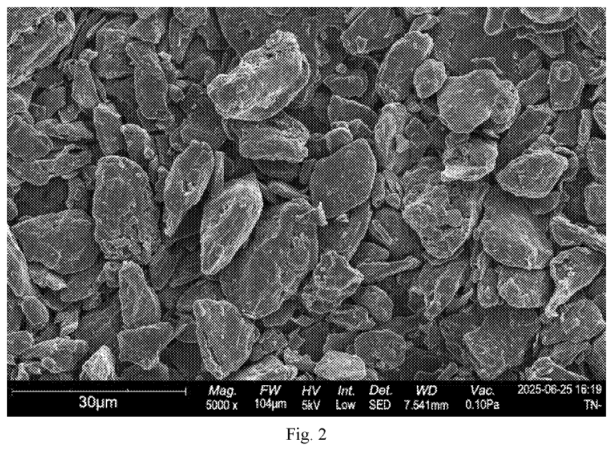

FIG. 2 is a morphology diagram of a coated waste layered carbon material with a focus on coating uniformity, showing the surface of the material after asphalt vapor phase infiltration—in-situ condensation coating. The result herein indicates that the continuous carbon film formed by dehydrogenation condensation of the small-molecule aromatic hydrocarbons, such as anthracene and phenanthrene, has completely covered all surface defects, with a seamless interface without cracks or peeling. The continuous carbon film has s a uniform thickness, showing that under the 10⁻² Pa ultra-high vacuum environment, the in-situ condensation of the small-molecule aromatic hydrocarbons is fully completed, with no oxidation or bubble residues. Such dense and uniform coating layer serves as structural foundation for subsequent high-temperature restoration and is a key prerequisite for ultimately increasing the initial coulombic efficiency to 93.1%.

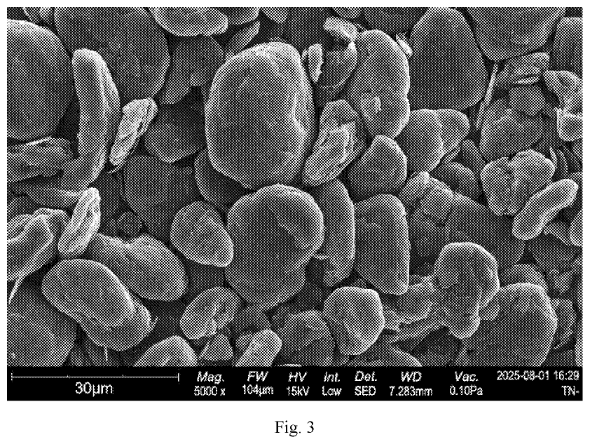

FIG. 3 is a morphology diagram of a material after gradient high-temperature restoration with a focus on structural integrity, showing the material surface has become smooth and intact with all defects eliminated; the edges and corners have become smooth, indicating that Stone Wales defects have been restored; the grain size has increased, which is approximately 20 μm, showing that the atomic migration energy barrier is reduced by 1.3 eV. A distinct layered stacking structure and the disappearance of amorphous regions, together with a Bernal stacking ratio of 96% verified by selected area electron diffraction (SAED) and the ID/IG ratio detected by Raman spectroscopy, collectively indicate that sp²-hybridized network and long-range crystalline order have been successfully restored. The result shows that the gradient high-temperature restoration procedure solves the industry challenge of ineffective high-temperature restoration.

FIGS. 1-3 shows a progressive restoration pathway of surface defect restoration→dense coating formation→crystal structure regeneration, demonstrating that the dry process enables deep regeneration of layered carbon materials. The solution of the present disclosure shows generational advantages in restoration thoroughness, structural integrity, and performance indicators, specifically, the specific capacity of 361.96 mAh/g, and the initial coulombic efficiency of 93.1%, while all-dry process eliminates wastewater and gas pollution.

Crystal structure analysis was performed by XRD using a Rigaku SmartLab diffractometer with Cu Kα radiation (λ=1.5406 Å) over a 2θ range of 20°-80°. After restoration, (d002) diffraction peak was located at 26.52°±0.05°, corresponding to an interlayer spacing of approximately 0.336 nm, with a full width at half maximum of ≤0.18°. The electrochemical performance was evaluated by half-cell testing at a 0.1 C rate, achieving the initial coulombic efficiency of ≥92%.

Although embodiments of the present disclosure have been shown and described above, it should be noted that the above embodiments are only illustrative, rather than limiting the present disclosure. Any changes, modifications, and replacement can be made by those skilled in the art within the scope of the present disclosure.

What is claimed is:

1. A method for dry recycling and structure regeneration of layered carbon materials, comprising:
(S10) pretreating a waste layered carbon material;
(S20) mixing a pretreated waste layered carbon material with asphalt, followed by gas-phase infiltration in a nitrogen atmosphere at 300-500° C. to allow small-molecule aromatic hydrocarbons to diffuse into defect sites of the pretreated waste layered carbon material, so as to obtain a mixture;
performing pyrolytic deposition on the mixture at 800° C. under vacuum to obtain a first intermediate product, wherein the small-molecule aromatic hydrocarbons undergo dehydrogenation condensation to release hydrogen gas and form polycyclic aromatic hydrocarbon radicals, and the polycyclic aromatic hydrocarbon radicals undergo in-situ condensation through polymerization at the defect sites of the pretreated waste layered carbon material to form a continuous carbon film; performing isostatic-pressing densification on the first intermediate product at a pressure of 5-7 MPa in an inert gas atmosphere to force the continuous carbon film to experience plastic flow and fill micropores with a size smaller than 50 nm to obtain a second intermediate product;
(S30) heating the second intermediate product from 800° C. to 1500° C. at a rate of 5-10° C./min to realize defect identification and transformation to obtain a third intermediate product; heating the third intermediate product from 1500° C. to 2500° C. at a rate of 10-12° C./min to realize atomic directional migration to obtain a fourth intermediate product; and heating the fourth intermediate product from 2500° C. to 2850° C., and keeping the fourth intermediate product at 2850° C. under an axial pulse pressure for 1-6 h to induce Bernal stacking to realize ordered lattice reconstruction, so as to obtain a fifth intermediate product; and
(S40) subjecting the fifth intermediate product to deagglomeration and magnetic separation to obtain a regenerated material.

2. The method of claim 1, wherein in step (S20), the asphalt accounts for 5-10 wt. % of the pretreated waste layered carbon material.

3. The method of claim 1, wherein the small-molecule aromatic hydrocarbons are anthracene and phenanthrene.

4. The method of claim 1, wherein the defect sites are lattice vacancies and interlayer cracks.

5. The method of claim 1, wherein in step (S20), the pyrolytic deposition is performed at a vacuum degree of 10⁻² Pa.

6. The method of claim 1, wherein the continuous carbon film has an amorphous-graphene hybrid structure with an intensity ratio of D-band to G-band (ID/IG ratio) of 0.45-0.55.

7. The method of claim 1, wherein in step (S20), the isostatic-pressing densification is performed to increase a density of the continuous carbon film to 1.6-1.9 g/cm³.

8. The method of claim 1, wherein during the defect identification and transformation, an oxygen-containing defect reaction is triggered as follows: C+O→CO₂; a CO concentration is controlled at 300 ppm, and Stone Wales defect rotation is activated to realize transformation of five-membered carbon rings and seven-membered carbon rings into six-membered carbon rings.

9. The method of claim 1, wherein during the atomic directional migration, under the guidance of the continuous carbon film, an atomic migration energy barrier is reduced, a vacancy filling energy barrier decreases by 1.3 eV, and an interlayer transition energy barrier decreases by 1.4 eV.

10. The method of claim 1, wherein in step (S30), the axial pulse pressure is 0.4-0.55 MPa, and is applied in a 5-second on/5-second off mode.
